(19) United States
(12) Patent Application Publication
(10) Pub. No.: US 2010/0041441 A1
(43) Pub. Date: Feb. 18, 2010

(54) ELECTRONIC APPARATUS

(75) Inventors: Masaru Kato, Tokyo (JP); Hirofumi Shimizu, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/402,619

(22) Filed: Mar. 12, 2009

(30) Foreign Application Priority Data
Aug. 12, 2008 (JP) P2008-208196

(51) Int. Cl. H04M 1/00

(52) U.S. Cl. 455/566

(57) ABSTRACT

According to an aspect of the invention there is provided an electronic apparatus including: a controller configured to execute a first application program and a second application program; a display module including a screen configured to simultaneously display a first window for the first application program and a second window for the second application program; an extraction module configured to extract information related to the first application program when the first and second windows are displayed on the screen and the first window is inactive; and a reference module configured to refer to the information in the second application program when the first and second windows are displayed on the screen and the second window is active.

The entire disclosure of Japanese Patent Application No. 2008-208196 filed on Aug. 12, 2008, including specification, claims, drawings and abstract is incorporated herein by reference in its entirety.

### BACKGROUND

1. Field of the Invention

One aspect of the invention relates to an electronic apparatus configured to execute a plurality of application programs and configured to display windows that respectively relate to the application programs, on the same screen.

2. Description of the Related Art

In an electronic apparatus such as a mobile phone, recently, a high-performance CPU or graphic chip is mounted and the processing power is remarkably improved, so that the electronic apparatus generally has a multitasking function which enables a plurality of applications to be simultaneously activated and operated. As typified by wide Video Graphics Array (VGA) and Wide Quarter VGA (QVGA), the resolution of a display device becomes higher. A mobile phone on which a two-screen displaying function (a function configured to simultaneously display two applications on one screen) that enables the multitasking function to be effectively used is mounted is developed.

For example, JP-A-2006-115213 discloses a mobile apparatus in which a plurality of applications are activated and simultaneously displayed The mobile apparatus is configured in the following manner. The case where a receiving process of receiving data based on a certain application program, and an application program executing process of processing the data received in the receiving process by an activated application program to be displayed are to be executed in the mobile apparatus will be considered. In a state where two kinds of application programs, i.e., first and second application programs are simultaneously activated as an application program executing process, when specific data are received based on the second application program, the display due to execution of the first application program, and that due to execution of the second application program are set to a certain display mode.

In a mobile phone having the two-screen displaying function, two or more applications can be simultaneously executed, but the number of application programs which can be simultaneously displayed is restricted to two, and the user is allowed to operate at a time only one of the displayed applications Therefore, there is a problem in that, in order to operate one application (for example, application B) in a state where another application (for example, application A) is operated, an operation subject must be switched from application A to application B.

### SUMMARY

According to an aspect of the invention, there is provided an electronic apparatus including: a controller configured to execute a first application program and a second application program; a display module including a screen configured to simultaneously display a first window for the first application program and a second window for the second application program; an extraction module configured to extract information related to the first application program when the first and second windows are displayed on the screen and the first window is inactive; and a reference module configured to refer to the information in the second application program when the first and second windows are displayed on the screen and the second window is active.

### BRIEF DESCRIPTION OF THE DRAWINGS

Embodiment may be described in detail with reference to the accompanying drawings, in which:

FIG. 1A is an exemplary front view showing a state where an electronic apparatus (mobile phone) of a first embodiment is opened;

FIG. 1B is an exemplary side view showing the state where the electronic apparatus (mobile phone) of the first embodiment is opened;

FIG. 2A is an exemplary front view showing a state where the electronic apparatus (mobile phone) of the first embodiment is closed;

FIG. 2B is an exemplary side view showing the state where the electronic apparatus (mobile phone) of the first embodiment is closed;

FIG. 3 is an exemplary functional block diagram of the electronic apparatus (mobile phone) of the first embodiment;

FIG. 4 is a screen view showing an example of a display screen in the electronic apparatus (mobile phone) of the first embodiment;

FIG. 5 is an exemplary schematic view illustrating the procedure of an information delivering process in the electronic apparatus (mobile phone) of the first embodiment;

FIG. 6 is an exemplary flowchart showing the procedure of the information delivering process in the electronic apparatus (mobile phone) of the first embodiment;

FIG. 7 is an exemplary view showing screen transition diagrams of the information delivering process in the electronic apparatus (mobile phone) of the first embodiment;

FIG. 8 is a data diagram showing an example of analysis condition information;

FIG. 9 is an exemplary schematic view illustrating the procedure of an information delivering process in an electronic apparatus (mobile phone) of a second embodiment;

FIG. 10 is a data diagram showing an example of meta-information.

FIG. 11 is a data diagram showing an example of mete-information correspondence information;

FIG. 12 is an exemplary flowchart showing the procedure of the information delivering process in the electronic apparatus (mobile phone) of the second embodiment; and

In FIG. 13 is an exemplary view showing screen transition diagrams of the information delivering process in the electronic apparatus (mobile phone) of the second embodiment.

### DETAILED DESCRIPTION OF THE EMBODIMENTS

### First Embodiment

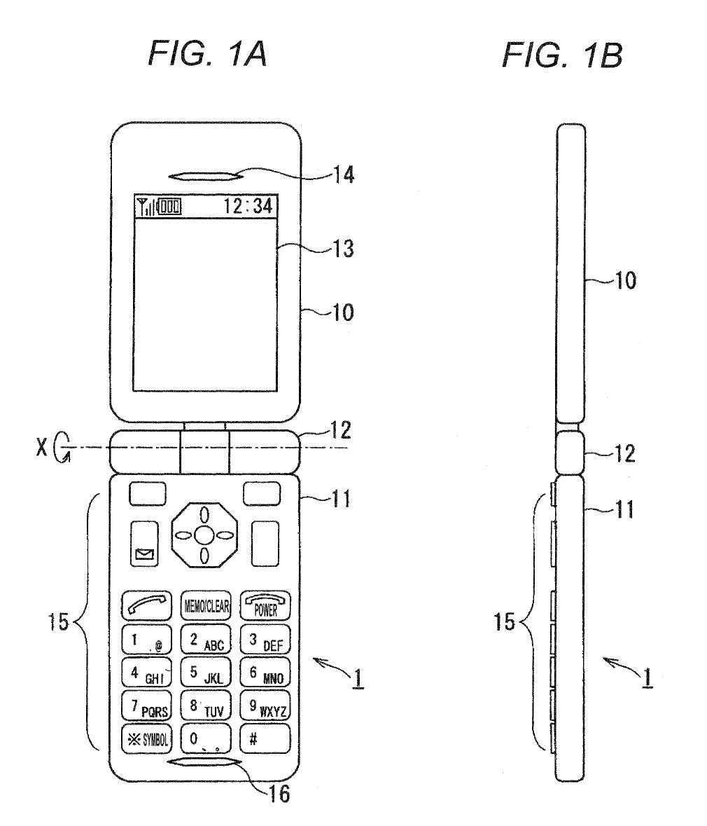

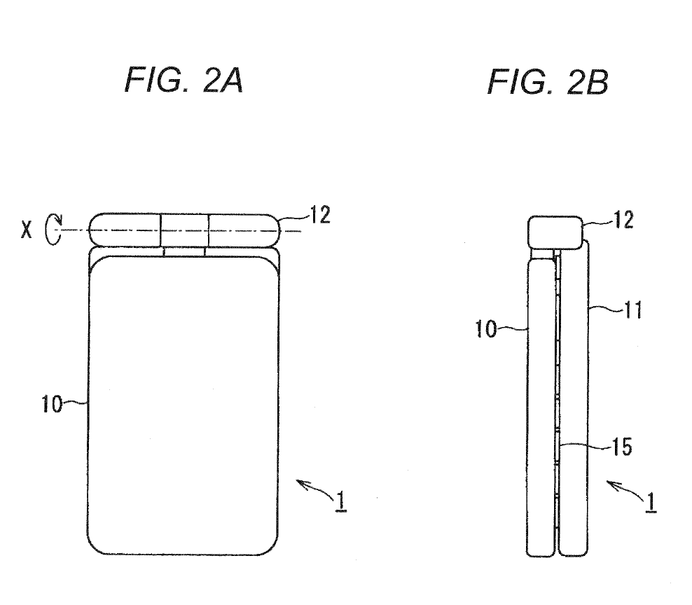

A first embodiment of the electronic apparatus of the invention will be described with reference to FIGS. 1A to 8. As the electronic apparatus of the first embodiment, a clamshell mobile phone 1 which is configured by swingably coupling two casings with one another will be exemplarily described. FIG. 1A is a front view showing a state where the mobile phone 1 is opened, and FIG. 1B is a side view showing the state where the mobile phone 1 is opened. FIG. 2A is a front view showing a state where the mobile phone 1 is closed, and FIG. 2B is a side view showing the state where the mobile phone 1 is closed.

As shown in FIGS. 1 and 2, the mobile phone 1 is configured mainly by an upper casing 10 having a rectangular plate-like shape, and a lower casing 11 which is substantially identical in shape with the upper casing 10. The upper casing 10 and the lower casing 11 are stacked so as to mutually cover one face in the closed state. The upper casing 10 and the lower casing 11 are hinge-coupled to each other across a hinge portion 12, and the upper casing 10 is formed so as to be swingable with respect to the lower casing 11 by a certain angle in an X direction shown in FIGS. 1A and 2A about the hinge portion 12. When the upper casing 10 is swung with respect to the lower casing 11, the mobile phone 1 is transformed from the closed state to the opened state or vice versa.

A display 13 for displaying display information which includes characters, images, and the like, and a speaker 14 for outputting sounds received from the communication counterpart are disposed in the inner face (the face opposed to the lower casing 11) of the upper casing 10. In the state where the mobile phone 1 is closed, the display 13 and the speaker 14 are covered by the lower casing 11 so as not to be exposed to the outside, but, when the upper casing 10 is swung with respect to the lower casing 11 to be transformed to the opened state, they are exposed to the outside.

Operation keys 15 configured by, for example, a power source key for switching over the ON/OFF states of the power source, a call key for performing a calling process, ten keys for inputting numerals and characters, and shortcut keys for activating a mailing function, a Web function, a television function, a radio function, and the like are disposed in the inner face (the face opposed to the upper casing 10) of the lower casing 11. Also, a microphone 16 for picking up sounds is disposed in the lower casing 11. In the state where the mobilephone 1 is closed, the operation keys 15 and the microphone 16 are covered by the upper casing 10 so as not to be exposed to the outside, but, when the upper casing 10 is swung with respect to the lower casing 11 to be transformed to the opened state, they are exposed to the outside.

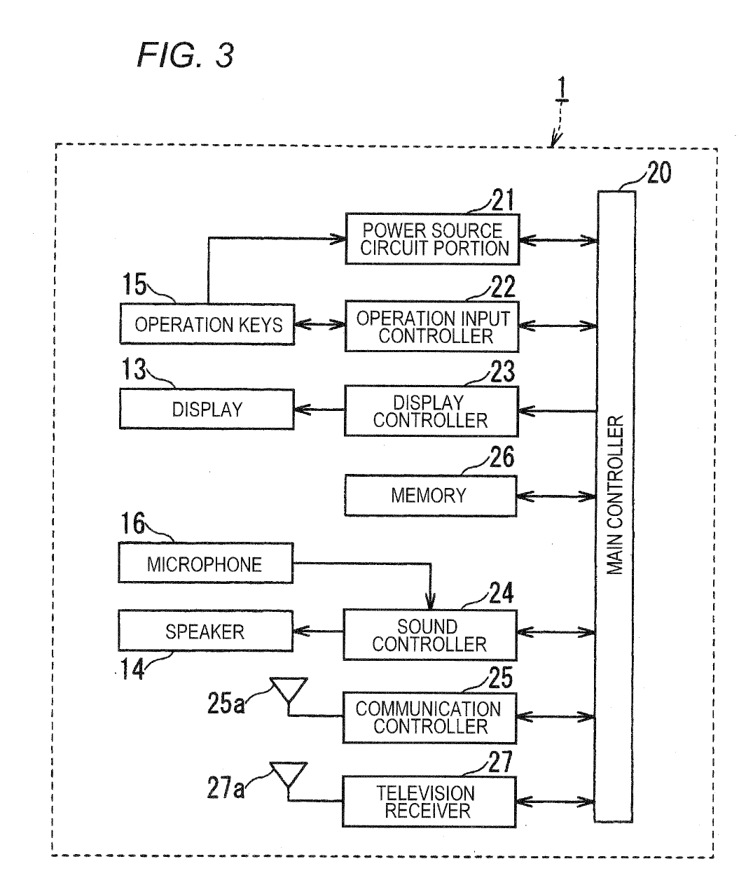

Next, the function of the mobile phone 1 will be described with reference to the functional block diagram shown in FIG. 3. As shown in FIG. 3, the mobile phone 1 is configured by mutually communicatably connecting together a main controller 20, a power source circuit portion 21, an operation input controller 22, a display controller 23, a sound controller 24, a communication controller 25, a memory 26, and a television receiving portion 27 through a bus.

The main controller 20 includes a Central Processing Unit (CPU), generally controls the mobile phone 1, and performs, for example, an information delivering process which will be described later, processes of executing application programs such as the mailing function, the Web function, and a game function, and other various calculating or controlling processes. The power source circuit portion 21 includes a power supply source (a battery or the like), switches over the ON/OFF states of the power source of the mobile phone 1 based on an input through the operation keys 15, and, when the power source is in the ON state, supplies an electric power from the power supply source to the various portions to enable the mobile phone 1 to operate.

The operation input controller 22 includes an input interface for the operation keys 15, and, when it is detected that one of the operation keys 15 is pressed, produces a signal indicative of the pressed operation keys 15. The signal is transmitted to the main controller 20. The display controller 23 includes a display interface for the display 13, and, based on the control of the main controller 20, displays document data, image data, and the like on the display 13.

Based on the control of the main controller 20, the sound controller 24 produces an analog sound signal from the sound picked up by the microphone 16, and converts the analog sound signal to a digital sound signal. When the sound controller 24 receives a digital sound signal, the sound controller converts the digital sound signal to an analog sound signal based on the control of the main controller 20, and outputs the sound signal as sound from the speaker 14.

Based on the control of the main controller 20, the communication controller 25 performs a spectrum despreading process on a reception signal received from a base station via an antenna 25a, to restore data. In accordance with instructions from the main controller 20, the data are transmitted to the sound controller 24 to be output from the speaker 14, transmitted to the display controller 23 to be displayed on the display 13, or recorded into the memory 26. When the communication controller 25 obtains sound data picked up by the microphone 16, data input through the operation keys 15, or data stored in the memory 26, the communication controller performs a spectrum spreading process on the data based on the control of the main controller 20, and transmits the resulting data to the base station via the antenna 25a.

The memory 26 is configured by: a Read Only Memory (ROM) a hard disk, and a nonvolatile memory which store programs for the process to be performed by the main controller 20, data required in the process, and the like; a database; a Random Access Memory (RAM) which temporarily stores data that are necessary in the process performed by the main controller 20; etc. It is assumed that various application programs to be executed by the main controller 20, and a program for the information delivering process which will be described later are stored in, for example, the ROM.

The television receiver 27 includes a television antenna 27a, and receives a television broadcast wave such as a terrestrial digital one-segment broadcast wave, a terrestrial digital broadcast wave, and a terrestrial 3-segment radio broadcast wave via the television antenna 27a. Then, the television receiver 27 performs a television viewing process in which the reception data of the received television broadcast wave are separated into a sound signal and an image signal, the image signal is displayed on the display 13 by the display controller 23, the sound signal is output from the speaker 14 by the sound controller 24.

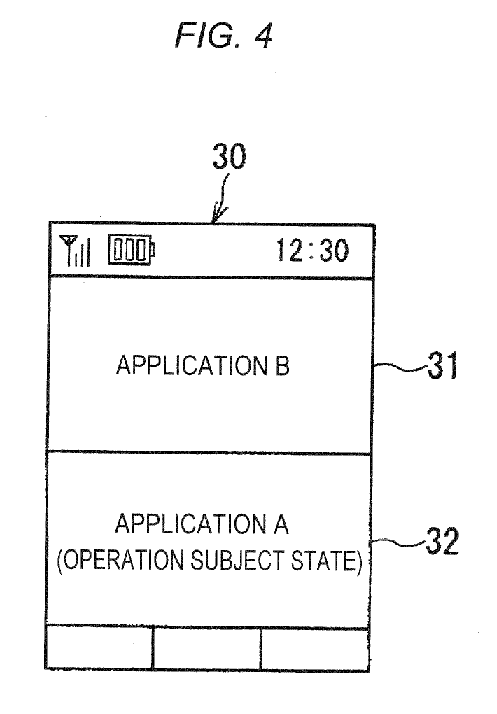

As shown in FIG. 4, the mobile phone 1 can simultaneously execute plural (for example, two) application programs, and has a double-window displaying function of simultaneously displaying windows respectively related to the two application programs on the same screen of the display 13.

In the mobile phone 1, when the double-window displaying function is performed, windows for a plurality of application programs can be simultaneously displayed, but the user is enabled to operate at a time only one of the displayed application programs. That is, only one of the windows is active at a time. Therefore, in order to operate one of the application programs (for example, application B) when the other application program (for example, application A) is executed, an operation subject has to be switched from application A to application B, that is, the active window has to be switched from a window for the application A to a window for the application B.

Assuming that a mail creating function is executed as application A and a Web browsing function is executed as application B, for example, when information of application B which is in a non-operation state is to be cited in application A which is in the state of the operation subject, for example, the following procedure is to be executed: (1) an application program which is in the operation subject state is switched over (from application A to application B); (2) displayed information is copied to a clip board; (3) the application program which is in the operation subject state is switched over (returned from application B to application A); and (4) the information is pasted from the clipboard. Therefore, the operation is complicated and bothersome. In the mobile phone 1, unlike a Personal Computer (PC) and the like, the screen display capability, an input device, and the like are limited, and hence the problem may be more prominent.

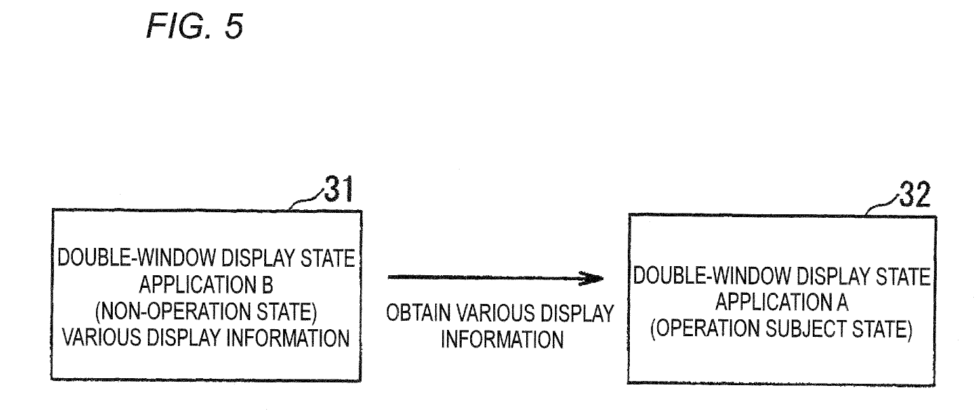

As shown in FIG. 5, therefore, the mobile phone 1 has a function of directly referring information displayed in the application program which is in a non-operation state (the information includes information outside a displayed region, that is, undisplayed information included in the same page), to an input assistance function for character inputting of an application program which is the operation subject, without switching an application program which is to be the operation subject. According to the configuration, it is possible to reduce the complexity and bother of the operation of switching over an application program when information related to an application program which is in a non-operation state is delivered to an application program which is in the operation subject state.

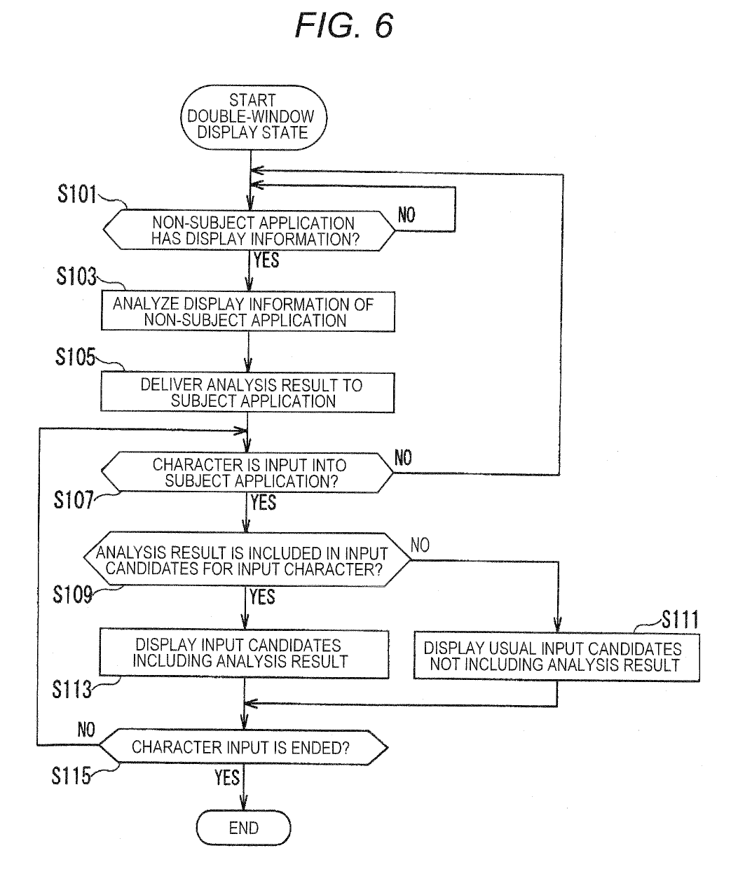

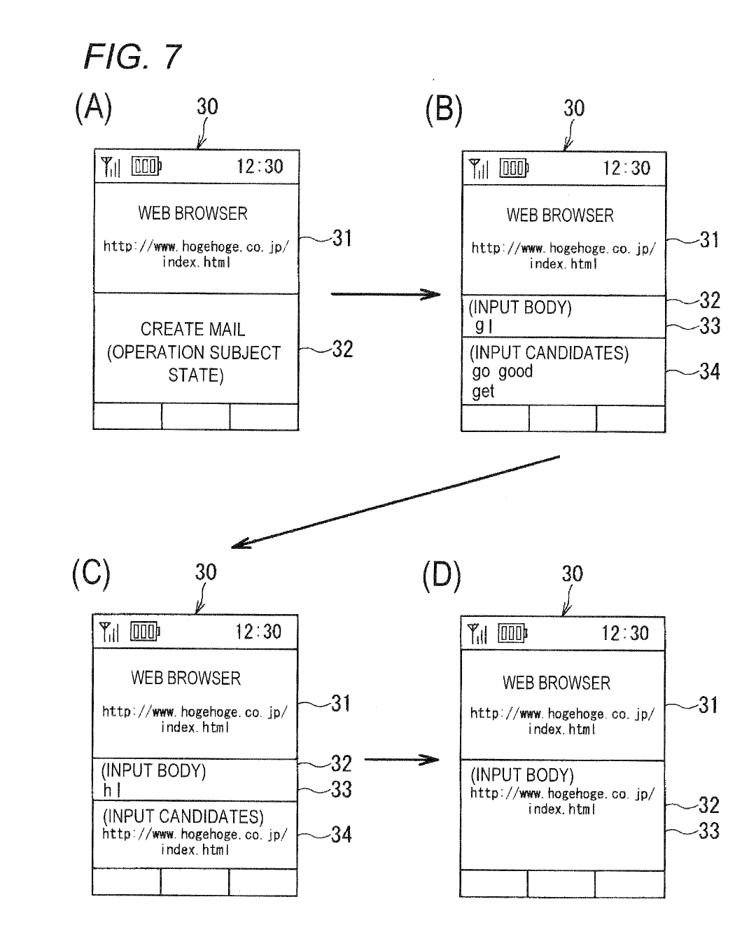

As described above, when two application programs are simultaneously executed and windows for the respective application programs are displayed on the same screen the mobile phone 1 performs the information delivering process of delivering information related to the application program that is in a non-operation state, in the application program which is one of the application programs, and which is in the operation subject state. The procedure which is performed by the mobile phone 1 in the information delivering process will be described with reference to the flowchart shown in FIG. 6 and the screen transition diagrams shown in FIG. 7. Hereinafter, the description will be made while the term “step” is omitted. For example, “step S101” is abbreviated as “S101”.

It is assumed that, in the mobile phone 1, the mail creating function is activated as application A which is in the operation subject state, and the Web browsing function is activated as application B which is in the non-operation state. At this time, as shown in (A) of FIG. 7, a display screen 30 of the display 13 includes a non-operation state application display section 31 in which information related to application B is to be displayed, and an operation subject state application display section 32 in which information related to application A that is in the operation subject state is to be displayed. For example, a Web page corresponding to a URL of “http://www.hogehoge.co.jp/index.html” is displayed in the non-operation state application display section 31.

First, the main controller 20 determines whether the application program which is in a non-operation state has display information or not (S101) When application B which is in a non-operation state has URL information that is display information which can be delivered to application A that is in the operation subject state, for example, it is determined that the application program has display information. If the application program does not have display information (No in S101), the main controller 20 waits without performing any further processing.

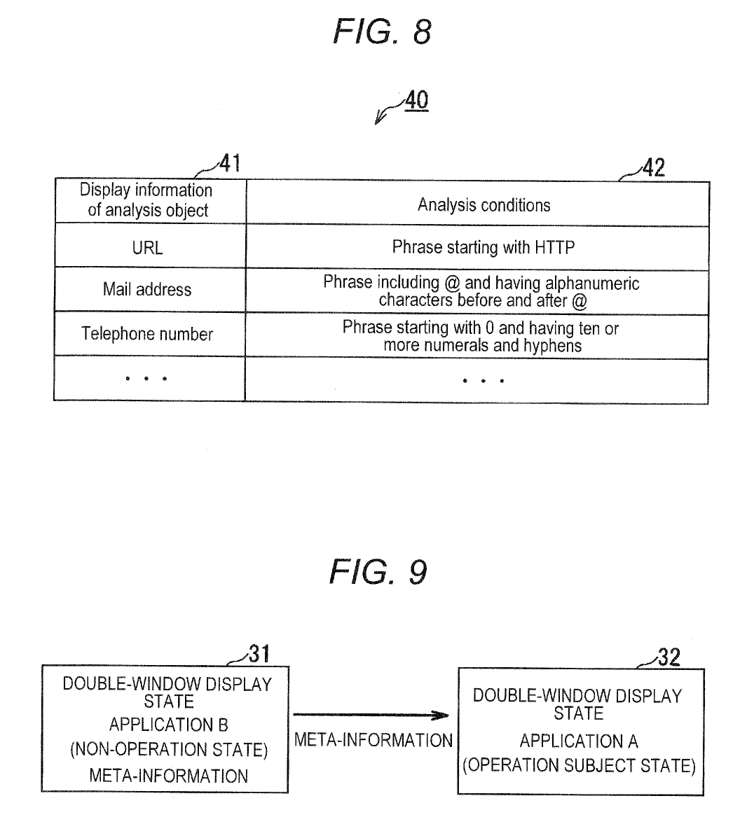

If the application program which is in the non-operation state has display information (Yes in S101), the main controller 20 analyzes the display information of the application program which is in the non-operation state, based on analysis conditions (S103). FIG. 8 shows an example of analysis condition information 40. The analysis condition information 40 is information in which analysis condition information 42 corresponds to display information 41 of an analysis object, and previously stored in the memory 26. As shown in FIG. 8, for example, display information which functions as analysis information is URL information, mail address information, telephone number information, and the like, the analysis conditions of URL information are a phrase starting with “http”, those of a mail address are a phrase which includes “@”, and which has alphanumeric characters before and after “@”, and those of a telephone number are a phrase which starts with “0”, and which has ten or more numerals and hyphens.

The main controller 20 delivers a result of the analysis in step S103 to the application program which is in the operation subject state (S105). In the case where a Web page corresponding to URL information of “http://www.hogehoge.co.jp/index.html” is browsed by the Web browsing function of application B, for example, the URL information is delivered to the mail creating function of application A.

The main controller 20 determines whether a character is input in the application program which is in the operation subject state or not (S107). At this time, in the case where an editor for character input is activated in the application program which is in the operation subject state and the user inputs a character by using the operation keys 15, for example, the main controller 20 determines that a character is input. If a character is not input (No in S107), the process returns to step S101 where the main controller 20 determines whether the application program which is in the non-operation state has display information or not.

If a character is input (Yes in S107), the main controller 20 determines whether the analysis result is included in input candidates for the input character or not (S109). As shown in (B) of FIG. 7, for example, a body input section 33 into which the body of a mail is to be input, and an input candidate selection section 34 in which input candidates are selectably displayed based on the character input into the body input section 33 are displayed in the operation subject state application display section 32 of the display screen 30 of the display 13.

In the inputting through the operation keys 15, for example, pressing the key “4” one time corresponds to the letter “g” of the alphabet, pressing the key “4” two times corresponds to the letter “h” of the alphabet. When the analysis result is URL information of “http://www.hogehoge.co.jp/index.html”, when the key “4” is pressed one time, namely, the analysis result is not included in the input candidates, and, when the key “4” is pressed two times, the analysis result is included in the input candidates. The analysis result is not restricted to one set of information, but may be configured by plural sets of information.

If the analysis result is not included in the input candidates for the input character (No in S109), the main controller 20 displays usual input candidates (input candidates which do not include the analysis result) in the input candidate selection section 34 (S111). As shown in (B) of FIG. 7, when the letter “g” is input (the key “4” is pressed one time) through the operation keys 15, for example, the analysis result which is delivered in step S105 is not included in the input candidates, and hence usual input candidates such as “go” and “good” are displayed.

If the analysis result is included in the input candidates for the input character (Yes in S109), the main controller 20 displays the input candidates which include the analysis result in the input candidate selection section 34 (S113). As shown in (C) of FIG. 7, when the character “h” is input (the key “4” is pressed two times) through the operation keys 15, for example, the analysis result which is delivered in step S105 is included in the input candidates, and hence input candidates including URL information of “http://www.hogehoge.co.jp/index.html” are displayed. The input candidates may include words starting with “h”, such as “home” and “hello”.

At this time, when the user selects the URL information from the input candidate selection section 34 through the operation keys 15, the URL information is input into the body input section 33 as shown in (D) of FIG. 7. Therefore, the user can easily cite information related to application B which is in the non-operation state, without switching the operation subject in application A which is in the operation subject state.

The main controller 20 determines whether the character inputting operation is ended or not (S115). At this time, for example, the main controller 20 determines that the character inputting operation is ended, based on that the editor function for character input is ended. If the character inputting operation is not ended (No in S115), the process returns to step S107, and the main controller again performs the processes of steps S107 to S115. If the character inputting operation is ended (Yes in S115), the process returns to step S101, and the main controller 20 again determines whether the application program which is in a non-operation state has display information or not.

As described above, when a plurality of application programs are executed and windows for the application programs are simultaneously displayed on the same screen, when the user performs character input in application A which is in the operation subject state, the mobile phone 1 obtains information related to application B which is an application program that is in a non-operation state, and presents the information to the user as a input candidate.

The mobile apparatus of the first embodiment can simultaneously execute a plurality of application programs, has the double-window displaying function of simultaneously displaying display screens for the application programs on the same screen, and can directly refer information related to an application program that is not the operation subject, as the input candidate in character input in an application program which is the operation subject, without switching an application program which is to be the operation subject. Therefore, it is possible to reduce the complexity, cumbrance, and bother of the user operation of referring information related to an application program which is in the non-operation state, in the application program which is the operation subject.

In the analysis condition information 40 shown in FIG. 8, a URL, a mail address, and a telephone number are shown as an example of display information of an analysis object. When the analysis conditions are increased, however, phrases such as an English word, a personal name, and a combination of alphabets, numerals, and symbols may be added as input candidates, so that the convenience can be further improved.

### Second Embodiment

A second embodiment of the electronic apparatus of the invention will be described with reference to FIGS. 1 to 4 and 9 to 13. Hereinafter, the same components as the first embodiment are denoted by the same reference numerals, and duplicated description will be omitted. As shown in FIGS. 1 and 2, the electronic apparatus (mobile phone 1) of the second embodiment has the same configuration as the mobile phone 1 of the first embodiment. Similarly with the mobile phone 1 of the first embodiment, as shown in FIG. 3, the electronic apparatus (mobile phone 1) of the second embodiment is configured by mutually communicatably connecting together the main controller 20, the power source circuit portion 21, the operation input controller 22, the display controller 23, the sound controller 24, the communication controller 25, the memory 26, and the television receiver 27 through a bus.

The mobile phone 1 of the first embodiment has the function of directly referring to display information of an application program which is in the non-operation state, in the input assistance function for character inputting of an application program which is the operation subject, without switching an application program which is to be the operation subject. In contrast, the mobile phone 1 of the second embodiment has a function of directly referring to meta-information of an application program which is in the non-operation state, in an application program which is the operation subject, without switching an application program which is to be the operation subject.

As shown in FIG. 4, similarly with the first embodiment, the mobile phone 1 of the second embodiment can simultaneously activate and execute plural (for example, two) application programs, and has the double-window displaying function of simultaneously displaying windows respectively related to the two application programs on the same screen of the display 13.

In the mobile phone 1, when the double-window displaying function is performed, windows for a plurality of application programs can be simultaneously displayed, but the user is enabled to operate at a time only one of the displayed application programs. In order to switch to the operation of one of the application programs (for example, application B) in a state where the other application program (for example, application A) is operated, therefore, the operation subject must be switched from application A to application B.

In the case where a mail creating function is executed as application A and a Web browsing function is executed as application B, when meta-information of application B which is in the non-operation state is to be cited in application A which is in the operation subject state, for example, the following procedure must be executed: (1) an application program which is in the operation subject state is switched over (from application A to application B); (2) the meta-information of application B is copied to a clipboard; (3) the application program which is in the operation subject state is switched over (returned from application B to application A); and (4) the information is pasted from the clipboard. Therefore, the operation is complicated and bothersome.

As shown in FIG. 9, therefore, the mobile phone 1 has a function of directly referring to meta-information of an application program which is in the non-operation state, in an application program which is the operation subject, without switching an application program which is to be the operation subject. According to the configuration, it is possible to reduce the complexity and bother of the operation of switching an application program when meta-information of the application program which is in the non-operation state is delivered, to the application program which is in the operation subject state.

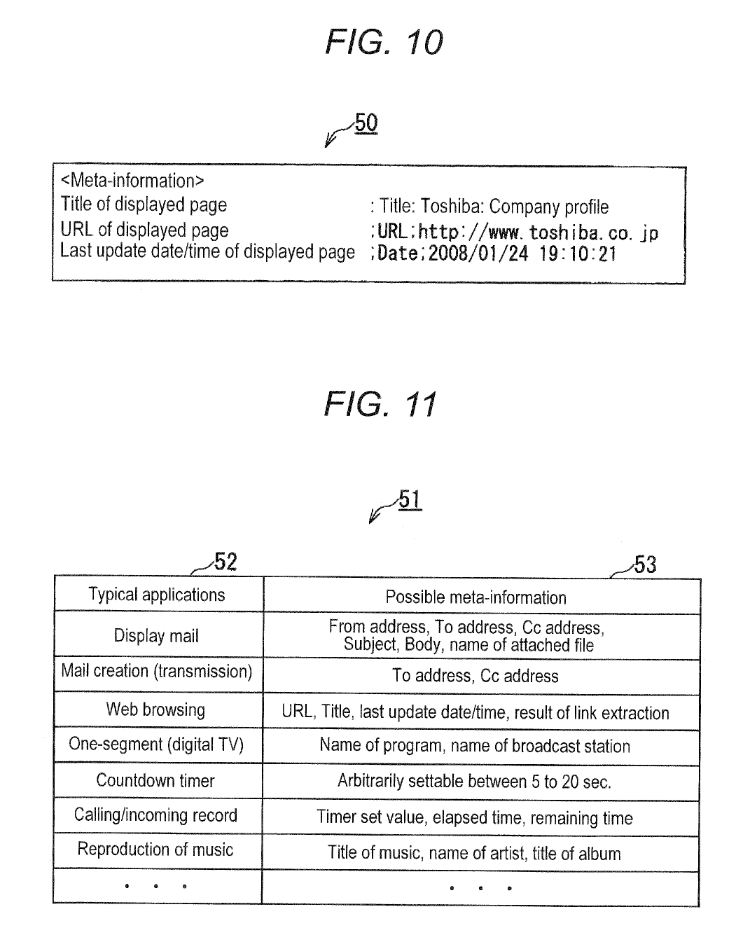

FIG. 10 shows an example of meta-information of an application program (for example, application B). As shown in FIG. 10, in meta-information 50 of application B having a Web browsing function, for example, “Toshiba: Company profile” is stored for “Title” which is the title of a displayed Web page, “http://www.toshiba.co.jp” is stored for “URL” which is the URL of the displayed Web page, and “2008/01/24 19:10:21” is stored for “Date” which is the last update date/time of the displayed Web page.

FIG. 11 shows an example of meta-information correspondence information 51 indicating meta-information which is supposed to appear in application programs. As shown in FIG. 11, the meta-information correspondence information 51 is information in which meta-information 53 which is supposed to appear is correspondent to application information 52 indicating application programs. According to the meta-information correspondence information 51 shown FIG. 11, in an application program for displaying a mail, for example, meta-information including From address, To address, Cc address, Subject, Body, and the name of an attached file is supposed to appear. In an application program (for example, application A) for creating (transmitting) a mail, meta-information including To address and Cc address is supposed to appear. In an application program (for example, application B) for executing Web browsing, meta-information including URL, Title, the last update date/time, a result of link extraction, and the like is supposed to appear.

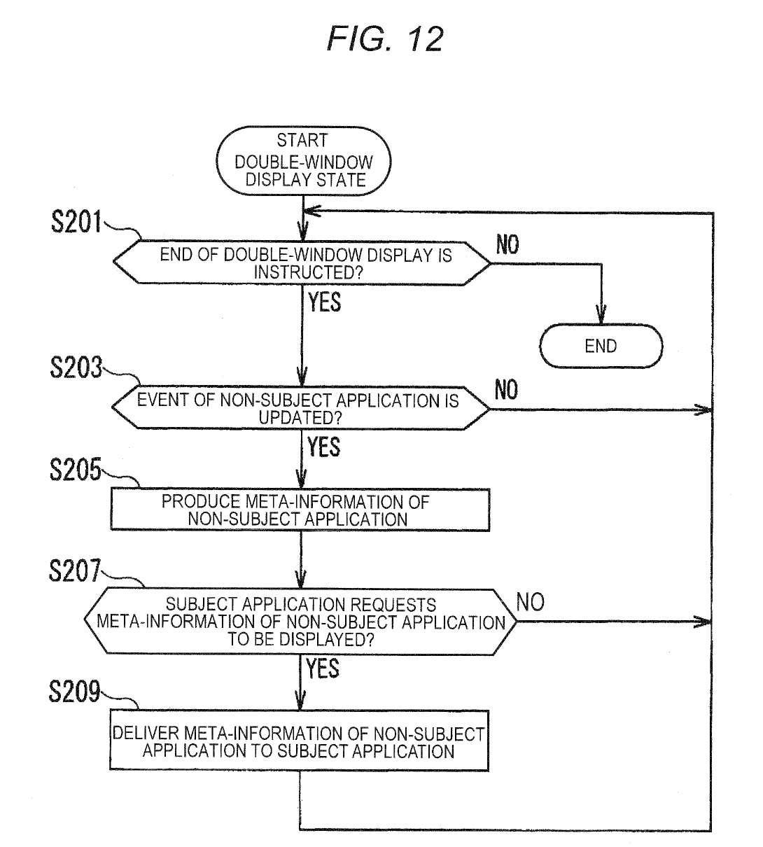

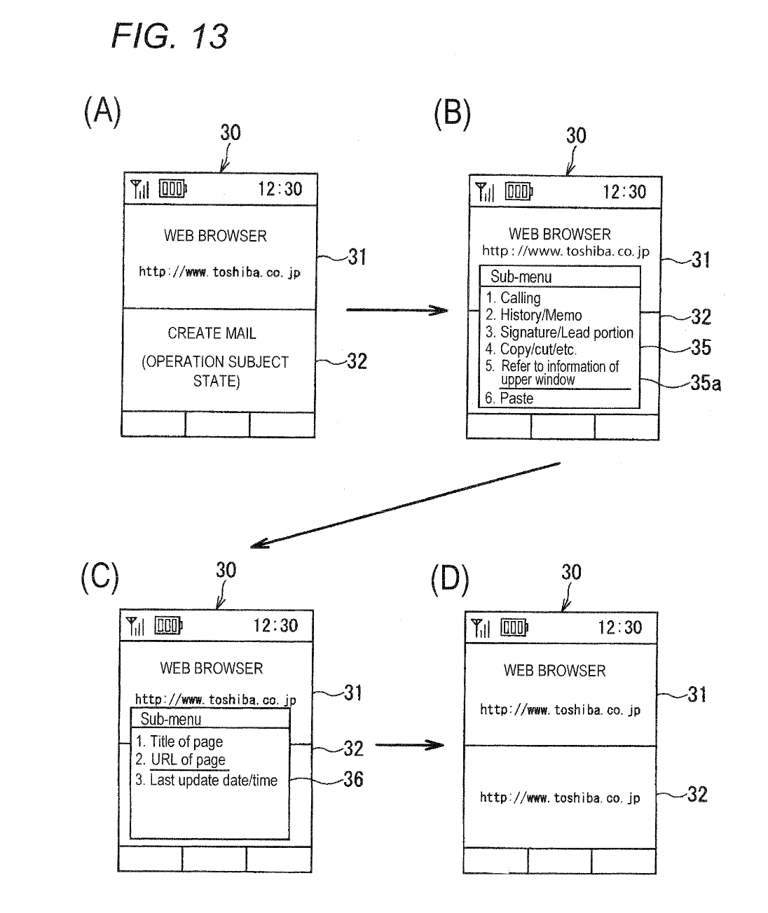

When two application programs are executed and screens for the application programs are displayed on the same screen, the mobile phone 1 of the second embodiment performs the information delivering process of delivering meta-information of the application program that is in a non-operation state based on the meta-information correspondence information 51, in the application program which is one of the application programs, and which is in the operation subject state. The procedure which is performed by the mobile phone 1 in the information delivering process will be described with reference to the flowchart shown in FIG. 12 and the screen transition diagrams shown in FIG. 13.

It is assumed that, in the mobile phone 1, the mail creating function is executed as application A which is in the operation subject state, and the Web browsing function is executed as application B which is in the non-operation state. As shown in (A) of FIG. 13, the display screen 30 of the display 13 includes the non-operation state application display section 33 in which information related to application B is to be displayed, and the operation subject application display section 32 in which information related to application A that is in the operation subject state is to be displayed. For example, a Web page corresponding to a URL of “http://www.toshiba.co.jp” is displayed in the non-operation state application display section 31.

First, the main controller 20 determines whether the end of the double-window display is instructed or not (S201). At this time, when the main controller 20 is instructed by, for example, user instructions through the operation keys 15 to terminate the execution of one or both of the application programs, the main controller determines that the end of the double-window display is instructed. If the end of the double-window display is instructed (Yes in S201), the main controller 20 terminates the one or both of the application programs to end the double-window display.

If the end of the double-window display is not instructed (No in S201), the main controller 20 determines whether an event of the application program which is in the non-operation state is updated or not (S203). In this case, the event means an event in which meta-information of the application program is changed, for example, the displayed Web page is changed, or the last update date/time of the displayed Web page is changed. If the event of the application program which is in the non-operation state is not updated (No in S203), the process returns to step S201 where the main controller 20 again determines whether the end of the double-window display is instructed or not.

If the event of the application program which is in the non-operation state is updated (Yes in S203), the main controller 20 produces meta-information of the application program in which the even has been updated (S205). At this time, as shown in FIG. 10, for example, the main controller 20 produces meta-information of application B which is an application program that is in the non-operation state.

The main controller 20 determines whether the display of the meta-information of the application program which is in the non-operation state is instructed in the application program which is in the operation subject state or not (S207). Based on user instructions through the operation keys 15, for example, the main controller 20 displays a sub-menu display section 35 on the display screen 30. As shown in (B) of FIG. 13, for example, the sub-menu display section 35 has a link (a link indicated by “See information of upper window”) 35a for displaying the meta-information of the application program which is in the non-operation state. When the link 35 is selected in response to user instructions through the operation keys 15, the main controller 20 determines that the display of the meta-information of the application program which is in the non-operation state is instructed.

If the display of the meta-information of the application program which is in the non-operation state is not instructed (No in S207), the process returns to step S201 where the main controller 20 again determines whether the end of the double-window display is instructed or not.

If the display of the meta-information of the application program which is in the non-operation state is instructed (Yes in S207), the main controller 20 delivers the meta-information of the application program which is in the non-operation state, i.e., the meta-information which is produced in step S205, to the application program which is in the operation subject state (S209). At this time, the main controller 20 displays a sub-menu display section 36 in which the meta-information of application B that is an application program in the non-operation state is selectably displayed. As shown in (C) of FIG. 13, for example, the sub-menu display section 36 has links for displaying the meta-information of application B, such as the page title, the page URL, and the last update date/time.

When one of the links is selected in response to user instructions through the operation keys 15, the main controller 20 determines that the display of the meta-information corresponding to the selected link, and displays the meta-information corresponding to the selected link 36a in the operation subject state application display section 32. In the case where the link of “page URL” is selected, for example, the main controller 20 displays “http://www.toshiba.co.jp” which is the URL of the Webpage that is displayed in application B, in the operation subject state application display section 32 as shown in (D) of FIG. 13.

Then, the process returns to step S201, and the main controller 20 again performs the processes of steps S201 to S209. As described above, when a plurality of application programs are simultaneously executed and screens for the application programs are simultaneously displayed on the same screen, the main controller 20 produces/updates as needed the meta-information of application B that is an application program in the non-operation state, whereby, in the case where the user wishes to refer to meta-information of application B in application A which is an application program in the operation subject state, application A is enabled to obtain the meta-information of application B, and the meta-information of application B is presented to the user as apart of the process of application A.

Even when it is determined in step S203 that an event of the application program which is in the non-operation state is not updated, when meta-information of the application program is not produced, the process proceeds to step S205, and the main controller 20 produces meta-information.

As the second embodiment, the example where meta-information of an application program in the non-operation state is presented to the user has been described. However, the invention is not restricted to this. Alternatively, meta-information may be used in a form where the user is not conscious of the reference to the meta-information. For example, meta-information may be used in an operation of selecting a conversion/input candidate in an input assistance function.

The second embodiment can simultaneously execute a plurality of application programs, has the double-window displaying function of simultaneously displaying windows for the application programs on the same screen, and can directly refer meta-information of an application program that is not the operation subject, in an application program which is the operation subject, without switching the application program which is to be the operation subject.

A case where any intention of the user is reflected to each of sets of information handled in a plurality of application programs which are simultaneously displayed by the double-window displaying function of the mobile phone 1 may be possible. Therefore, data cooperation which is conscious of relationships of the sets of information is enabled in a form where the respective sets of information are referred.

Although the invention has been described with reference to the mobile phone 1, the invention is not restricted to this, and may be any electronic apparatus which executes an application program, such as a Personal Handy phone System (PHS), a Personal Digital Assistants (PDA), a portable music player, a portable video camera, and a portable video game machine.

What is claimed is:

1. An electronic apparatus comprising:
a controller configured to execute a first application program and a second application program;
a display module comprising a screen configured to simultaneously display a first window for the first application program and a second window for the second application program;
an extraction module configured to extract information related to the first application program when the first and second windows are displayed on the screen and the first window is inactive; and
a reference module configured to refer to the information in the second application program when the first and second windows are displayed on the screen and the second window is active.

2. The electronic apparatus of claim 1, further comprising a reception module configured to receive an input of a character,
wherein the reference module is configured to present the information as an input assistance when the first and second windows are displayed and the reception module receives the input.

3. The electronic apparatus of claim 1, wherein:
the first window is located on an upper area of the screen and the second window is located on a lower area of the screen when the second application program is active.

4. An electronic apparatus comprising:
a controller configured to execute a first application program and a second application program;
a display module comprising a screen configured to simultaneously display a first window for the first application program and a second window for the second application program;
an extraction module configured to extract meta-information of the first application program when the first and second windows are displayed on the screen and the first window is inactive; and
a reference module configured to refer to the meta-information in the second application program when the first and second windows are displayed on the screen and the second window is active.

5 The electronic apparatus of claim 4, further comprising:
a presentation module configured to present a plurality of pieces of meta-information extracted by the extraction module; and
a reception module configured to receive selection of any of the plurality of pieces of meta-information,
wherein the reference module is configured to refer to the selected meta-information in the second application program when the first and second windows are displayed and the selection is received.

6. The electronic apparatus of claim 4, further comprising a detection module configured to detect a change of the meta-information in the first application program,
wherein the extraction module is configured to extract the meta-information of the first application program when the detecting module detects the change.

7. The electronic apparatus of claim 1, wherein:
the first window is located on an upper area of the screen and the second window is located on a lower area of the screen when the second application program is active.
